(19) United States
(12) Patent Application Publication
(10) Pub. No.: US 2009/0029274 A1
(43) Pub. Date: Jan. 29, 2009

(54) METHOD FOR REMOVING CONTAMINATION WITH FLUORINATED COMPOSITIONS

(75) Inventors: Erik D. Olson, Shakopee, MN (US); Philip G. Clark, Eden Prairie, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/782,766

(22) Filed: Jul. 25, 2007

(51) Int. Cl. C11D 17/00; G03G 17/00

(52) U.S. Cl. 430/53; 510/407

(57) ABSTRACT

A method of removing contamination from a substrate having an ion-implanted region is described. The method comprises applying a composition comprising a fluorinated solvent and a co-solvent to the substrate in an amount sufficient to assist in the removal of contamination from the substrate. As contaminant is removed, metal patterns or other desired features on the substrate remain. Additionally, the composition for removing contamination is not harmful to the user or the substrate (i.e., non-flammable and/or non caustic).

### BACKGROUND OF THE INVENTION

Semiconductor manufacture traditionally has been categorized into two processes: front end of line (FEOL) and back end of line (BEOL). FEOL processing includes the formation of transistors, contacts, and metal plugs. BEOL processing encompasses the formation of interconnects, which are used to carry signals across a semiconductor device.

Traditionally, FEOL is recognized as a non-metal process, which typically involves depositing and patterning films for the gate structure and ion implanting. Ion implantation adds dopants to the substrate to create source and drain areas. A gate, made of polysilicon, is used as a relay to control the transfer of electrons between the source and drain. As the semiconductor industry is moving towards increased densification and miniaturization, semiconductor gate size is decreasing and the electrical properties of polysilicon make it less desirable for those smaller size gates. As technology evolves, the semiconductor industry is moving toward a new gate material, such as metal, to replace polysilicon.

In metal gate fabrication, a wafer is coated with an insulator, such as silicon oxide. Metal deposits are then patterned onto the coated wafer. Next, ions are implanted onto the wafer to modify its electrical properties, such as creating sources and drains. Typically ions are implanted into specific areas by the use of masks, which can be made of photoresist. The mask acts as a blanket, and as the ions impinge on the wafer surface, the features covered by the mask are protected from the ions. Afterward, the ion-contaminated mask is removed, resulting in a substrate with source and drain areas and metal gates.

Removal of contaminants is important for semiconductor device performance, device yield, and reliability. Contaminants, such as particles or sub-particles of metals, metal oxides, etch residues, or polymer residue, could create an electrical short between the source and drain or could cause openings or voids, which create high resistivity in metal interconnects. Contamination removal is necessary during FEOL processing and BEOL processing to allow the circuit to operate as designed.

A number of methods for removing contaminants (such as ion-contaminated masks) during the manufacture of polysilicon gates are known in the art, including dry chemical methods and wet aqueous chemical methods.

Removing contamination from a wafer without damaging the wafer can be challenging. For example, it can be difficult to remove an unwanted surface without damaging adjacent regions such as the ion-implanted regions or the metal deposits, which can be sensitive to and easily removed with harsh chemical treatments. It can also be difficult to identify cleaning compositions that are safe for widespread use, because many available compositions are flammable and/or caustic.

### SUMMARY OF THE INVENTION

There is a need for removing contamination from a substrate, which contains an ion-implanted region, whereby the contaminant is removed while metal patterns or other desired features on the substrate remain intact. There is also a need for removing contamination from a substrate having an ion-implanted region, whereby a decontamination composition for removing contamination is not harmful to the user or the substrate (i.e., nonflammable and/or non caustic).

In one embodiment, a method of removing contamination from a substrate containing an ion-implanted region by using a composition comprising a fluorinated solvent and a co-solvent is described.

In another embodiment, a process comprising coating a wafer with photoresist, exposing the substrate to ions, and removing the photoresist coating with a composition comprising a fluorinated solvent and a co-solvent is described.

The above summary is not intended to describe each disclosed embodiment or every implementation of the present invention. The detailed description which follows, more particularly exemplifies illustrative embodiments.

### BRIEF DESCRIPTION OF DRAWINGS

Embodiments of the present disclosure are illustrated by way of example, and not limitation, in the accompanying drawings in which:

FIGS. 1A-1D are schematics of a cross-sectional portion of an in-process integrated circuit during a transistor fabrication process.

FIG. 2 is a schematic of a cross-sectional portion of an in-process integrated circuit with an ion-implanted region and an interconnect layer.

### DETAILED DESCRIPTION

This disclosure relates to the use of a composition comprising a fluorinated solvent and a co-solvent to remove contamination. More specifically, this disclosure relates to the removal of contamination (e.g., photoresist) from a substrate that has an ion-implanted region such as an integrated circuit or other small semiconductor component.

### Decontamination Composition

In this invention, a decontamination composition of fluorinated solvent and co-solvent can be used to remove contaminants from substrates. First, the decontamination composition will be described.

The co-solvents may be chosen to modify or enhance the solvency properties of a decontamination composition for a particular use. Co-solvents can be fluorinated or nonfluorinated and can include: alcohols, ethers, alkanes, alkenes, amines, cycloalkanes, esters, ketones, haloalkenes, haloaromatics, aromatics, siloxanes, hydrochlorocarbons, and combinations thereof, more preferably, alcohols, ethers, alkanes, alkenes, haloalkenes, cycloalkanes, esters, aromatics, haloaromatics, hydrochlorocarbons, hydrofluorocarbons, and combinations thereof, most preferably in some embodiments, alcohols, ethers, alkanes, alkenes, haloalkenes, cycloalkanes, esters, aromatics, haloaromatics, and combinations thereof.

Representative examples of co-solvents that can be used include: 1-methoxy 2-propanol, dipropylene glycol, propylene glycol acetate, ethylene glycol diacetate, 1,2-propanediol monomethyl ether acetate, dipropylene glycol monomethyl ether transdichloroethylene, trifluoroethanol, pentafluoropropanol, hexafluoroisopropanol, hexafluorobutanol, methanol, ethanol, isopropanol, t-butyl alcohol, methyl t-butyl ether, methyl t-amyl ether, 1,2-dimethoxyethane, cyclohexane, 2,2,4-trimethylpentane, n-decane, terpenes (e.g., a-pinene, camphene, and limonene), trans-1,2-dichloroethylene, cis-1,2-dichloroethylene, methylcyclopentane, decalin, methyl decanoate, t-butyl acetate, ethyl acetate, diethyl phthalate, 2-butanone, methyl isobutyl ketone, naphthalene, toluene, p-chlorobenzotrifluoride, trifluorotoluene, bis(trifluoromethyl)benzenes, hexamethyl disiloxane, octamethyl trisiloxane, methylene chloride, chlorocyclohexane, 1-chlorobutane, 1,1-dichloro-1-fluoroethane, 1,1,1-trifluoro-2,2-dichloroethane, 1,1,1,2,2-pentafluoro-3,3-dichloropropane, 1,1,2,2,3-pentafluoro-1,3-dichloropropane, and combinations thereof, more preferably, 1-methoxy-2-propanol, ethylene glycol diacetate, 1,2-propanediol monomethyl ether acetate, dipropylene glycol monomethyl ether, and combinations thereof.

Fluorinated solvents may be added to the decontamination composition, for example to reduce the flammability of the co-solvent. While not being restricted by theory, the fluorinated solvent may also assist in decreasing the surface tension of the decontamination composition. Fluorinated solvents can include solvents that are partially fluorinated. Partially fluorinated solvents can include: hydrofluoropolyethers, hydrochlorofluoroethers, segregated and non segregated hydrofluoroethers, hydrofluoroketones, fluoroketones, hydrofluoroalkanes, and combinations thereof; more preferably segregated and non segregated hydrofluoroethers, hydrofluoroalkanes, and combinations thereof.

Representative fluorinated solvents can include: methyl nonafluorobutyl ether, methyl nonafluoroisobutyl ether, ethyl nonafluorobutyl ether, ethyl nonfluoroisobutyl ether, 3-ethoxy-1,1,1,2,3,4,4,5,5,6,6,6-dodecafluoro-2-trifluoromethyl-hexane, 1,1,1,2,3,3-hexafluoro-4-(1,1,2,3,3,3-hexafluoro-propoxy)-pentane, 1,1,1,2,2,3,4,5,5,5-decafluoro-3-methoxy-4-(trifluoromethyl)-pentane, 1,1,2,2-tetrafluoro-1-(2,2,2-trifluoroethoxy)-ethane, 1,1,1,2,3,4,4,5,5,5-decafluoropentane, and combinations thereof.

The co-solvent and fluorinated solvent may be used in percentages of co-solvent and fluorinated solvent such that the resulting decontamination composition has no flash point (as measured, for example, following ASTM D-3278-96 e-1). A typical range of co-solvent can be from 1% to 95%, 10% to 80%, 30% to 75%, 30% to 50%, 70% to 85%, or even 85% to 90% (w/w) (weight/weight). A typical range of fluorinated solvent can be from 99% to 5%, 90% to 20%, 70% to 25%, 70% to 50%, 30% to 15%, or even 15% to 10% (w/w).

In one embodiment, the decontamination compositions containing a fluorinated solvent and co-solvent can be an azeotrope or azeotrope-like. An azeotrope composition exhibits either a maximum boiling point that is higher than, or a minimum boiling point that is lower than, each of the individual solvent components. Azeotrope-like compositions boil at temperatures that are either above each of the individual solvent components or below the boiling point of the each of the individual solvent components. The azeotrope composition is included in the range of azeotrope-like compositions for a particular mixture of substances.

The concentration of the fluorinated solvent and the co-solvent in a particular azeotrope-like composition may vary substantially from the corresponding azeotropic composition, and the magnitude of this permissible variation depends upon the co-solvent. In some embodiments, the azeotropic-like composition comprises essentially the same concentrations of the fluorinated solvent and the co-solvent as comprise the azeotrope formed between them at ambient pressure. In some embodiments, the azeotrope-like compositions exhibit no significant change in the solvent power of the composition over time. Typically, azeotropes and azeotrope-like compositions retain some of the properties of the individual component solvents, which may enhance performance and usefulness over the individual components because of the combined properties.

Azeotrope or azeotrope-like compositions can include: 1,1,1,2,2,3,4,5,5,5-decafluoro-3-methoxy-4-trifluoromethyl-pentane and 1-methoxy-2-propanol, or 1,1,1,2,3,3-hexafluoro-4-(1,1,2,3,3,3-hexafluoro-propoxy)-pentane and 1-methoxy-2-propanol, or 1-ethoxy-nonafluorobutane and 1-methoxy-2-propanol (see attorney docket number 63286US002 (Owens), filed on even date herewith (U.S. Ser. No. ______) the disclosure of which is herein incorporated by reference).

In addition to the fluorinated solvent and co-solvent, other compounds such as those described below may be added to the azeotrope-like composition so long as they do not interfere in the formation of the azeotrope-like composition.

In some embodiments, the decontamination composition may contain more than one fluorinated solvent. In other embodiments, the decontamination composition may contain more than one co-solvent.

The decontamination compositions containing fluorinated solvent and co-solvent can be homogeneous or heterogeneous. The heterogeneous decontamination composition can be agitated or sonicated before and/or during use to achieve a substantially homogeneous mixture.

In some embodiments, the decontamination compositions may contain, in addition to the fluorinated solvent and the co-solvent, other additives. Additives may include corrosion inhibitors, surfactants, lubricants, acids, and combinations thereof. The additives may be present in small amounts, preferably less than 10,000 parts per million (ppm), less than 1,000 ppm or even less than 100 ppm. In some embodiments, corrosion inhibitors are added to the decontamination composition to inhibit corrosion of metals, for example, benzotriazole (BTA) or uric acid. In some embodiments, additional surfactants (such as secondary alcohol ethoxylates, fluorinated compounds, or perfluoroalkyl sulfonamido compounds) or solvents (such as isopropyl alcohol) may be added to the decontamination composition to, for example, improve the dispersion or the solubility of materials, such as water, soils, or coating materials and/or improve the wetting ability of the substrate surface. In some embodiments, small amounts of lubricious additives (such as perfluoropolyether lubricants or fluoropolymers) may be added to the decontamination composition to, for example, enhance the lubricating properties. In still other embodiments, acid solutions may be added to the decontamination composition to, for example, etch the silicon or silicon oxide surface. The acid solutions (for example, hydrofluoric acid and/or nitric acid) can be aqueous or anhydrous.

If desirable for a particular application, the decontamination composition can further contain one or more dissolved or dispersed gaseous, liquid, or solid additives (for example, carbon dioxide gas, oxidizers, chelating agents, surfactants, stabilizers, antioxidants, corrosion inhibitors or activated carbon).

Additionally, in one embodiment, the decontamination composition is non-aqueous or essentially non-aqueous. Essentially non-aqueous refers to a decontamination composition containing below about 10,000 ppm, below about 1,000 ppm or even below about 100 ppm of water.

The decontamination composition can be non-flammable, non-caustic, and capable of removing the contaminant without adversely impacting desired features such as metal deposits on the substrate.

Non-flammable decontamination compositions are desirable in the manufacture of semiconductor devices for safety and cost concerns. Non-flammability can be assessed by using standard methods such as ASTM D-3278-96 e-1, D56-05 “Standard Test Method for Flash Point of Liquids by Small Scale Closed-Cup Apparatus”.

Non-caustic decontamination compositions are decontamination compositions that are not corrosive to the user and/or the substrate, such as the metal or metal oxide.

### Process of Semiconductor Fabrication

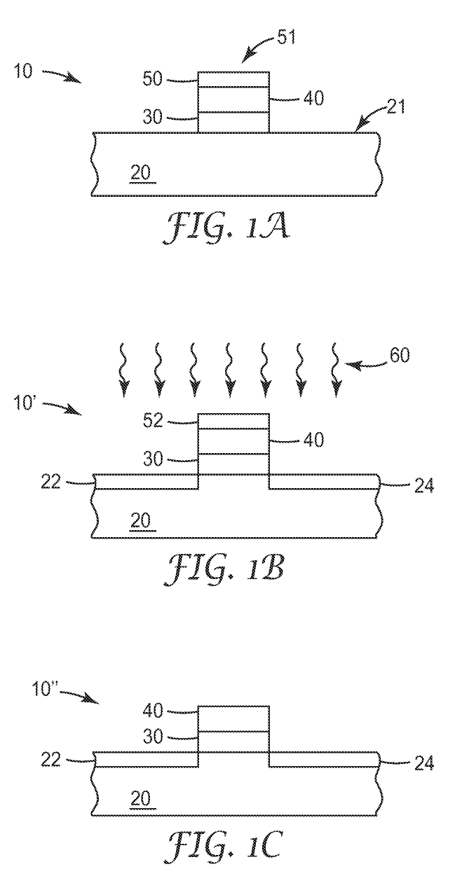

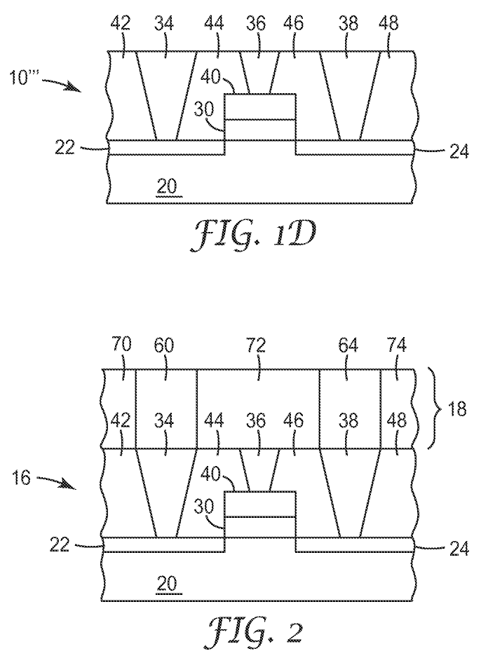

Having now described the decontamination composition, the semiconductor fabrication process will be explained using FIGS. 1A-1D, which illustrate a transistor fabrication process, and FIG. 2, which illustrates an in-process integrated circuit with an interconnect layer. The figures described below are for illustrative purposes and are by way of example only.

Example schematics of a transistor fabrication process are illustrated in FIGS. 1A-1D. In FIG. 1A, wafer 20 is coated with insulator 30. Metal deposits 40 are patterned onto the insulator-coated wafer. Photoresist 50 is then applied, followed by lithographic processing. The photoresist is developed leaving in-process integrated circuit 10, which has surface of photoresist 51 and surface of bare wafer 21.

In FIG. 1B, in-process integrated circuit 10 shown in FIG. 1A is exposed to ions 60, resulting in in-process integrated circuit 10′. In-process integrated circuit 10′ comprises ion-implanted regions 22 and 24, and ion-implanted photoresist 52. Ion-implanted photoresist 52 may be fully or partially implanted with ions depending on the ion-implantation method and conditions used. After ion implantation, ion-implanted photoresist 52 is removed from in-process integrated circuit 10′ via a contamination removal process described in greater detail below, resulting in in-process integrated circuit 10″ (FIG. 1C). In-process integrated circuit 10″ comprises metal deposit 40 and ion-implanted regions 22 and 24.

After ion implantation and removal of ion-implanted photoresist, plugs of metal 34, 36, and 38 are fabricated onto ion-implanted regions 22 and 24, and metal deposit 40, resulting in in-process integrated circuit 10′″ (FIG. 1D). The metal plugs (e.g., tungsten) act as contacts, connecting the transistor to subsequent layers (e.g., interconnect layers). Insulating material 42, 44, 46, and 48 are fabricated for support and insulation around the plugs of metal 34, 36, and 38.

An interconnect layer may then be fabricated onto in-process integrated circuit 10′″, resulting in in-process integrated circuit 16, which has interconnect layer 18. A schematic depicting a portion of in-process substrate with ion-implanted regions 22 and 24, metal deposit 40, metal plugs 34, 36, and 38, and interconnect layer 18 is shown in FIG. 2. Using known fabrication techniques (such as lithography, CMP (chemical mechanical planarization), thin-film deposition, thin-film etching, and ion implantation), metal interconnects 60 and 64 are fabricated onto metal plugs 34 and 38. The metal interconnects act as electrical wires to connect transistors together. Insulating material 70, 72, and 74 is fabricated around metal interconnects 60 and 64 for support and insulation. Fabrication techniques are used to fabricate additional interconnect layers on top of interconnect layer 18 to connect transistors together and eventually to pathways that connect the circuit to external devices, such as a circuit board.

Described above is one way of fabricating a transistor and interconnect layer. Of course, the particular fabrication method and process steps are not critical to the present invention. The disclosed decontamination compositions and processes may be used with many semiconductor devices to remove contaminants from a substrate that contains an ion-implanted region.

### Materials

In various embodiments, contaminants are removed from a substrate. Substrates can include articles used in the manufacture of semiconductors or other small components or devices, including for example, wafers or chips. The substrates can include: silicon, silicon on insulator (SOI), germanium, gallium arsenide, gallium phosphide, indium phosphide (InP), other III-V and II-VII compound semiconductors, other complex alloys, and other suitable substrates.

The substrates can be coated (entirely coated, partially coated, or at least partially coated) with various layers including, for example, oxide, metal, and photoresist layers, and hard masks.

Oxide layers and hard masks can include: silicon dioxide, silicon nitride, amorphous silicon, amorphous carbon, tetraethylorthosilicate (TEOS), polysilicon, and high density plasma (HDP).

Metal and alloy deposits or layers can be used to form metal gates on the substrate. Metal and alloy can include: aluminum, tungsten, tungsten silicide, tantalum, tantalum nitride, titanium, titanium nitride, titanium silicide, cobalt, cobalt silicide, nickel, nickel silicide, platinum, platinum silicide, hafnium, hafnium silicate, zirconium, molybdenum, ruthenium, vanadium, palladium, and combinations thereof, more preferably tungsten.

Photoresist layers can include negative tone and positive tone photoresist. Negative tone photoresist can include acrylic negative-tone. Positive tone photoresist can include: diazide naphthoquinone (DNQ) positive-tone and chemically amplified positive-tone resists, g-line, i-line, deep ultraviolet (DUV), 193 nm, 248 nm, and extreme ultraviolet (EUV).

Metal and alloy deposits or layers can be used to form plugs, which connect the transistor to the interconnect layer. Metal and alloy can include: tungsten, aluminum, and combinations thereof.

Metal and alloy deposits or layers can be used to form interconnects of the interconnect layer. Metal and alloy can include: aluminum, tungsten, tungsten silicide, tantalum, tantalum nitride, titanium, titanium nitride, titanium silicide, cobalt, cobalt silicide, nickel, nickel silicide, platinum, platinum silicide, hafnium, zirconium, copper, molybdenum, ruthenium, vanadium, palladium and combinations thereof, more preferably copper, aluminum and combinations thereof.

The insulating material of the interconnect layer and between the metal plugs can include low dielectric constant (low-k dielectric) materials, such as fluorine-doped silicon dioxide (e.g., fluorinated silica glass); carbon-doped silicon dioxide or organo-silicate glass (e.g., Black Diamond™ from Applied Materials, Inc., Santa Clara, Calif.; Aurora™ from ASM International, N.V., Bilthoven The Netherlands, and Coral™ from Novellus Systems, Inc., San Jose, Calif.); porous silicon dioxide, which introduces pores into any of the films that will lower the dielectric constant; and spin-on organic polymeric dielectrics (e.g., polyimide, polynorbornenes, benzocyclobutene, and polytetrafluoroethylene (PTFE)).

### Ion Implantation

Implantation of a substrate with ions can be used to modify the properties of the substrate, e.g., ions can be used to dope a material to make a non-conductive material, conductive. During implantation, ions are accelerated toward the substrate at energies high enough to bury them below the substrate's surface. Generally, the modification of the surface during ion implantation depends on the ion energy, ion flux, and type of ions used. Ion implantation may be categorized into high dose and low dose implantation. High-dose ion-implantation applications are typically characterized by a dose about greater than 1×10¹⁵ ions/cm². Low dose implantation applications are typically characterized by a dose about less than 1×10¹⁴ ions/cm².

Ion implantation is typically categorized into beamline and plasma-based implantation. In beamline ion implantation, a stream of ions is extracted from an ion source. The ions are accelerated and focused into a beam, which is scanned or rastered across the target. Types of beamline ion implantation include: medium current, high current, and high energy. Another technique is plasma-based ion implantation. In plasma-based implantation, a voltage bias is placed between a plasma and a substrate. Ions in the plasma are accelerated across the plasma and impact the substrate where they become implanted. There are several forms of plasma-based implantation methods, including plasma immersion ion implantation (PIII), plasma source ion implantation (PSII), plasma doping (PLAD), and ion shower.

For integrated circuit fabrication, the ions selected for doping have conductive properties. Ions that are typically used for doping are arsenic ions, phosphorous ions, boron ions, boron difluoride ions, indium ions, antimony ions, germanium ions, silicon ions, nitrogen ions, hydrogen ions, helium ions, and mixtures thereof. More specifically, for N-type doping, typically arsenic ions and/or phosphorous ions are used, and for P-type doping, typically boron ions are used.

An ion-implanted region is a particular area that has an increased concentration of ions. The ion-implanted region of a substrate could have a concentration gradient of ions, which decreases across a portion of the substrate e.g., the ion-implanted region on a substrate may have an increased concentration of ions at the substrate surface and the concentration of ions decreases based on the distance from the substrate surface, perhaps to a point within the substrate where the ion concentration no longer changes. The substrate may have an ion-implanted region that has a distinct ion boundary, i.e., a high ion concentration that abruptly terminates. Further, the substrate may have an ion-implanted region than has both a concentration gradient and a distinct ion boundary.

### Contaminant Removal

Following ion implantation, the substrate may comprise for example, ion-implanted regions, metal deposits, and ion-implanted photoresist. The substrate may then be contacted with a decontamination composition in an amount sufficient to assist in the removal of contamination from the substrate. That is, an amount of decontamination composition such that the contaminants are at least partially dissolved and/or removed, however, desired features such as a metal pattern on the substrate is not substantially adversely affected.

In this disclosure, contaminants refer to undesirable materials on a surface. For example, materials such as light hydrocarbon contaminants; higher molecular weight hydrocarbon contaminants such as mineral oils and greases; fluorocarbon contaminants such as perfluoropolyethers, and chlorotrifluoroethylene oligomers (hydraulic fluids, lubricants); silicone oils and greases; solder fluxes; particulates; and other materials encountered in precision, electronic, and metal cleaning can be considered to be contaminants. Various embodiments of the present invention also are particularly useful in the removal of hydrocarbon contaminants, fluorocarbon contaminants, photoresist, particulates, and water.

As a means of removing the contamination, wiping, dipping, spraying, mechanical agitation, megasonic or ultrasonic cleaning, etc., may be employed singly or in combination. The decontamination composition can be applied by any known means. For example, soaking the substrate into the decontamination composition, dipping the substrate into the decontamination composition, spraying the decontamination composition onto the substrate, dripping the decontamination composition onto the substrate and spinning the substrate, applying a stream of decontamination composition onto a spinning substrate, passing the substrate through a sheet of decontamination composition, exposing the substrate to decontamination composition vapor, and combinations thereof.

In addition to decontaminating with the fluorinated solvent and co-solvent, this decontamination composition can be used in conjunction with other techniques, for example, the substrate with an ion-implanted region also may be exposed to a dry chemical method. For example, a decontamination composition and ashing (e.g., oxygen plasma ashing) can be used in combination to decontaminate a substrate. In one embodiment, a substrate that is contaminated with, for example, ion-implanted photoresist, and that has an ion-implanted region can be at least partially ashed (i.e., ashed or partially ashed) then the substrate can be contacted with a decontamination composition of fluorinated solvent and co-solvent. In another embodiment, a substrate that is contaminated with, for example, ion-implanted photoresist, and that has an ion-implanted region, can be contacted with a decontamination composition then the substrate can be at least partially ashed. In still another embodiment, the substrate that is contaminated with, for example, ion-implanted photoresist, and that has an ion-implanted region, can be decontaminated using repetitive contact with the decontamination composition and the dry chemical method (e.g., ashing) until the contaminant is at least partially dissolved and/or removed. For example, a substrate that is contaminated with, for example, ion-implanted photoresist, and that has an ion-implanted region, can be contacted with a decontamination composition then the substrate can be at least partially ashed then contacted again with a decontamination composition and at least partially ashed again.

In one embodiment, contamination is removed during FEOL processing. For example, contamination is removed from a substrate that contains an ion-implanted region at the surface of the substrate.

In one embodiment, photoresist is used as a mask during the manufacture of a substrate. The photoresist is coated over a substrate such as a wafer, patterned and developed. The substrate is then implanted with ions, which dope at least the portion of the substrate coated with the photoresist. The patterned photoresist acts as a mask, limiting where the ions are able to implant. After doping with ions, at least a portion of the photoresist that is implanted with ions is removed with a composition of a fluorinated solvent and a co-solvent.

In another embodiment, metal gates are fabricated onto the substrate. Metal deposits (such as tungsten, copper or aluminum, preferably tungsten) are patterned onto the substrate. Photoresist is then applied to the substrate, followed by lithographic processing. The photoresist is developed leaving a pattern of photoresist, metal, and an underlying silicon wafer. Then the substrate is exposed to ion implantation, where the ions are implanted into at least a portion of the substrate surface and the photoresist. After implantation, at least a portion of the ion-implanted photoresist is then removed from the substrate, leaving an ion-doped wafer, which can now act as an electrical contact between the patterned metal.

In still another embodiment, contamination is removed during BEOL processing. For example, contamination is removed from a substrate that contains an ion-implanted region that is not at the surface of the substrate.

In another embodiment, an interconnect layer is provided. After implantation and the removal of the ion-implanted photoresist from the substrate, the interconnect layer is fabricated onto the substrate. Standard techniques are used (lithography, CMP, thin film depositing, thin film etching, and ion implantation) to fabricate the interconnect layer, which comprises an insulator material and a metal interconnect. Multiple interconnect layers also can be fabricated onto the substrate.

In another embodiment, an article is provided. The article contains an ion-implanted region and is decontaminated (at least partially removing at least one contaminant) using the composition of at least a fluorinated solvent and a co-solvent. The article is a product of semiconductor fabrication and can include an integrated circuit.

Advantages and embodiments of this invention are further illustrated by the following examples, but the particular materials and amounts thereof recited in these examples, as well as other conditions and details, should not be construed to unduly limit this invention. All materials are commercially available or known to those skilled in the art unless otherwise stated or apparent.

### EXAMPLES

### Examples 1-15 and Comparative Examples C1-C3

Silicon wafers coated with a photoresist material, patterned, developed, and then exposed to a low dose ion-implant process using less than 1 KeV (kilo electron volt) of energy, were cleaved to produce test samples ranging in size from about 0.5 cm×0.5 cm to about 2 cm×2 cm.

Shown in Table 1 are the descriptions of the materials used in the following experiments.

TABLE 1
Description of materials used

| Designator | Chemical Name | Manufacturer |
|---|---|---|
| HFE 7100* | Methoxy-nonafluorobutane | 3M Company, St. Paul, MN |
| | (isomeric mixture) | |
| HFE 7200** | Ethyl nonafluorobutyl ether | 3M Company, St. Paul, MN |
| | (isomeric mixture) | |
| HFE 7300*** | Decafluoro-3-methoxy-4- | 3M Company, St. Paul, MN |
| | trifluoromethyl pentane | |
| TFTE† | 1,1,2,2-tetrafluoro-1-(2,2,2- | AGC America, Inc., Charlotte, NC |
| | trifluoroethoxy)-ethane | |
| DDFP†† | 2,3-dihydrodecafluoropentane | Dupont Fluoroproducts, |
| | | Wilmington, DE |
| PM | 1-methoxy-2-propanol | Alfa Aesar, Ward Hill, MA |
| PMA | 1,2-propanediol monomethyl ether | Alfa Aesar, Ward Hill, MA |
| | acetate | |
| 1-propanol | 1-propanol | Sigma-Aldrich, St. Louis, MO |
| NMP | n-methyl pyrolidone | Alfa Aesar, Ward Hill, MA |
| EA | Ethylene acetate | Alfa Aesar, Ward Hill, MA |
| IPA | Isopropanol | Sigma-Aldrich, St. Louis, MO |

*3M ™ Novec ™ 7100 Engineered Fluid
**3M ™ Novec ™ 7200 Engineered Fluid
***3M ™ Novec ™ 7300 Engineered Fluid
†Asahiklin ™ AE-3000
††DuPont ™ Vertrel ® XF

Compositions of fluorinated solvent and co-solvent were prepared on a weight to weight basis (w/w) in small beakers (ranging in size from 50 mL to 250 mL) according to Table 2 below. The beakers containing the composition were placed on a magnetic stirring hot plate and the composition was stirred with a Teflon® stir-bar.

A test sample, as described above, was immersed in the composition and held in place for a prescribed period of time with a disposable plastic forceps. Aluminum foil was used to cover the top of the beaker to minimize evaporation and contamination. Unless otherwise indicated, all examples were tested at ambient temperature (approximately 25° C.). Examples tested at elevated temperatures were heated on the hot plate. A glass thermometer was placed in the beaker and used to measure the temperature of the composition during testing. A stopwatch was used to measure the exposure time.

The test sample was removed from the composition at a designated exposure time. After exposure, the test samples were rinsed by dipping in a separate beaker containing only the fluorinated solvent used in the experiment. For the Comparative Examples, HFE 7100 was used to rinse neat NMP and neat 1-propanol, and HFE 7300 was used to rinse neat PM and neat PMA.

The test sample was dried using compressed air and inspected visually by eye to determine the amount of photoresist removed. The amount of photoresist removed was qualitatively rated as low (some removal but less than 50%), medium (approximately 50% removed), high (more than 50% removed, but not completely clear) and complete (complete removal). The results of low dose ion-implanted photoresist removed are shown in Table 2 below.

TABLE 2
Examples 1-15 and Comparative Examples C1-C4

| | | | | | Ion- |
|---|---|---|---|---|---|
| | | | | | implanted |
| | Fluorinated | | Co-Solvent(s) | Exposure | Photoresist |
| Example | Solvent | Co-Solvent(s) | (% w/w) | Time (min) | Removed |
| 1 | HFE 7100 | PM | 20 | 180 | Low |
| 2 | HFE 7100 | PM | 30 | 180 | Low |
| 3 | HFE 7100 | NMP | 20 | 180 | Low |
| 4 | HFE 7100 | NMP | 30 | 180 | Low |
| 5 | HFE 7100 | EA | 30 | 30 | Medium |
| 6 | HFE 7100 | EA | 30 | 30 @ 55° C. | High |
| 7 | HFE 7100 | 1-propanol | 30 | 30 | Medium |
| 8 | HFE 7300 | PM | 25 | 30 | Complete |
| 9 | HFE 7300 | PM | 30 | 30 | Complete |
| 10 | HFE 7300 | PM | 70 | 60 | Complete |
| 11 | HFE 7300 | PM/IPA | 30/4.5 | 60 | Low |
| 12 | HFE 7300 | PMA | 30 | 60 | Medium |
| 13 | HFE 7300 | PM/PMA | 20/20 | 60 | High |
| 14 | TFTE | PM | 30 | 60 | Low |
| 15 | DDFP | PM | 30 | 60 | Low |
| C1 | None | PM | 100 | 30 | Complete |
| C2 | None | PMA | 100 | 90 | Complete |
| C3 | None | NMP | 100 | 60 | Complete |
| C4 | None | 1-propanol | 100 | 60 | Complete |

### Examples 16-25 and Comparative Examples C5-C6

Examples 16-25 and Comparative Examples C5-C6 were tested as described above with the exception that the test sample had a patterned photoresist that was exposed to a high dose ion-implant process using less than 100 KeV of energy. The results of high dose ion-implanted photoresist removed are shown in Table 3 below.

TABLE 3
Examples 16-25 and Comparative Examples C5-C6

| | | | | | Ion- |
|---|---|---|---|---|---|
| | | | | | implanted |
| | Fluor- | | Co- | | Photo- |
| Exam- | inated | Co- | Solvent(s) | Exposure | resist |
| ple | Solvent | Solvent(s) | (% w/w) | Time (min) | Removed |
| 16 | HFE 7100 | EA | 30 | 30 | Low |
| 17 | HFE 7100 | EA | 30 | 30 @ 55° C. | Low |
| 18 | HFE 7100 | 1-propanol | 30 | 30 | Low |
| 19 | HFE 7300 | PM | 20 | 180 | Low |
| 20 | HFE 7300 | PM | 20 | 60 @ 65° C. | High |
| 21 | HFE 7300 | PM | 25 | 45 | High |
| 23 | HFE 7300 | PM | 30 | 120 @ 45° C. | Complete |
| 24 | HFE 7300 | PM/PMA | 10/10 | 90 | Medium |
| 25 | HFE 7300 | PM/PMA | 20/20 | 90 | High |
| C5 | None | PM | 100 | 45 | Complete |
| C6 | None | 1-propanol | 100 | 60 | High |

### Examples 26-30

Examples 26-30 were tested as follows. Compositions of 80% (w/w) PM were made with each of the following fluorinated solvents: HFE 7100, HFE 7200, HFE 7300, TFTE, and DDFP. Each composition (30 g) was placed in a small glass vial with a snap-top plastic cap. A 1-centimeter square test sample (high dose ion-implanted test sample described above) was placed with the photoresist side up at the bottom of the vial and capped. The vials remained stationary (no mixing or agitation) for 60 minutes (min). The test sample was removed from the vial, rinsed with water and air dried. The results of high dose ion-implanted photoresist removed are shown in Table 4 below.

TABLE 4
Examples 26-30

| | Fluor- | | Weight % | Exposure | Ion-implanted |
|---|---|---|---|---|---|
| Exam- | inated | Co- | Co-Solvent | Time | Photoresist |
| ple | Solvent | Solvent | (w/w) | (min) | Removed |
| 26 | HFE 7100 | PM | 80 | 60 | High |
| 27 | HFE 7200 | PM | 80 | 60 | High |
| 28 | HFE 7300 | PM | 80 | 60 | Complete |
| 29 | TFTE | PM | 80 | 60 | High |
| 30 | DDFP | PM | 80 | 60 | High |

### Reactivity to Tungsten

Silicon wafers were plated with tungsten (approximately 300 angstroms thick) then exposed to compositions for extended times at ambient temperature as shown in Table 5 below.

TABLE 5
Examples 31-32 and Comparative Examples C7-C10

| | | | Weight % | |
|---|---|---|---|---|
| | Fluorinated | | Co-Solvent | Exposure |
| Example | Solvent | Co-Solvent | (w/w) | Time |
| 31 | HFE 7300 | PM | 20 | 90 min |
| 32 | HFE 7300 | PM | 30 | 28 days |
| C7 | None | PM | 100 | 3 days |
| C8 | None | PMA | 100 | 3 days |
| C9 | None | PM | 100 | 28 days |
| C10 | HFE 7300 | None | 0 | 28 days |

After exposure, the tungsten plated wafers were examined under an optical microscope (Optiphot, Nikon, Melville, N.Y.) at 100× magnification for metal dissolution. No signs of metal dissolution were observed.

### Flammability Testing

Compositions of fluorinated solvent and co-solvent were tested for flashpoint following ASTM D-3278-96 e-1 “Flash Point of Liquids by Small Scale Closed-Cup Apparatus” with the following exceptions. The closed-cup apparatus used was a Setaflash Series 7 Plus Automatic Ramp Flash Point Tester, Model 72000-0 (Stanhope-Seta, Surrey, UK). This automated flashpoint testing apparatus is calibrated at least annually for accuracy of the flashpoint using a p-xylene reference standard. For testing, a sample was added to the cup of the automated flashpoint testing apparatus. The starting temperature for the flashpoint determination was based on the lowest flashpoint of the components, if known, (e.g., if the composition contained PM, PM has a flashpoint around 88° F. (31.1° C.) so the first flashpoint test was conducted at around 88° F.). Otherwise, the flashpoint analysis was started at around 68° F. (20° C.) (e.g., room temperature). After 1 min elapsed, a slide was automatically opened and a test flame applied. A flash was detected by the instrument and confirmed visually. If the flash was not observed, the instrument was set to automatically ramp at 2° F./min (1.1° C./min). After ramping up 2° F. (1.1° C.), the instrument was held at that temperature for 1 min, the slide opened, and the flame inserted. The instrument continued to ramp, equilibrating for 1 min and taking a flashpoint every 2° F. (1.1° C.), until a flash was detected or until the sample appeared to decompose, whichever came first. Decomposition appeared to occur when temperatures reached either 100° F. (37.7° C.) or 140° F. (60° C.). If a flash was detected by the instrument, a fresh sample was put in the cup, heated to the instrument-detected flashpoint and the flashpoint was confirmed by the instrument and visually. If the flashpoint was not observed, the sample was automatically ramped as discussed previously. Once the flashpoint was narrowed down, a fresh sample for each flashpoint test was used and the temperature was manually raised and lowered to further narrow down the flashpoint. The flashpoint was reported as the mean of duplicate determinations to the nearest 1° F. (1° C.). Generally, the flashpoint was confirmed by a visual observation of flashpoint on two fresh samples, unless the analyst ran out of material. The reported flashpoint results were corrected for barometric pressure at 97.9 kPa. The flashpoints of Examples 33-40 and C11-C12 are shown in Table 6. “None” designates that no flash point was identified.

TABLE 6
Flashpoint Determination

| | Fluorinated | | Co-Solvent(s) | Flashpoint |
|---|---|---|---|---|
| Example | Solvent | Co-Solvent(s) | (% w/w) | (° F. (° C.)) |
| 33 | HFE 7300 | PM | 80 | None |
| 34 | HFE 7300 | PM | 30 | None |
| 35 | HFE 7300 | PM | 20 | None |
| 36 | HFE 7300 | PM/IPA | 30/10 | None |
| 37 | HFE 7300 | PM/IPA | 30/4.5 | None |
| 38 | HFE 7300 | PM/IPA | 11/4.5 | None |
| 39 | HFE 7100 | PM | 30 | None |
| 40 | HFE 7100 | PM | 20 | None |
| C11 | None | PM | 100 | 88 (31) |
| C12 | HFE 7300 | PM | 90 | 88 (31) |

As shown in Tables 2, 3, and 4 decontamination compositions of fluorinated solvent and co-solvent were able to remove both high dose and low dose ion-implanted photoresist from a wafer. As shown in these tables, the solvent choice, weight percentage of components, and exposure conditions may impact the removal of ion-implanted photoresist. The decontamination compositions appear not to be reactive to tungsten based on an assessment under an optical microscope and are non-flammable based on closed-cup flashpoint testing following ASTM D-327-96 e-1.

Foreseeable modifications and alterations of this invention will be apparent to those skilled in the art without departing from the scope and spirit of this invention. This invention should not be restricted to the embodiments that are set forth in this application for illustrative purposes. All publications and patents are herein incorporated by reference to the same extent as if each individual publication or patent was specifically and individually indicated to be incorporated by reference.

What is claimed is:

1. A method of removing contamination from a substrate having an ion-implanted region, the method comprising applying a composition comprising a fluorinated solvent and a co-solvent to the substrate in an amount sufficient to assist in the removal of contamination from the substrate.

2. The method of claim 1, wherein the fluorinated solvent comprises at least one of a hydrofluoroether and a hydrofluoroalkane.

3. The method of claim 2, wherein the hydrofluoroether comprises at least one of: methyl nonafluorobutyl ether, methyl nonfluoroisobutyl ether, ethyl nonafluorobutyl ether, ethyl nonfluoroisobutyl ether, 3-ethoxy-1,1,1,2,3,4,4,5,5,6,6,6-dodecafluoro-2-trifluoromethyl-hexane, 1,1,1,2,3,3-hexafluoro-4-(1,1,2,3,3,3-hexafluoro-propoxy)-pentane, 1,1,1,2,2,3,4,5,5,5-decafluoro-3-methoxy-4-(trifluoromethyl)-pentane, and 1,1,2,2-tetrafluoro-1-(2,2,2-trifluoroethoxy)-ethane.

4. The method of claim 3, wherein the hydrofluoroalkane is 1,1,1,2,3,4,4,5,5,5-decafluoropentane.

5. The method of claim 1, wherein the co-solvent comprises at least one of: an alcohol, an ether, an alkane, an alkene, a haloalkene, a cycloalkane, an ester, an aromatic, and a haloaromatic.

6. The method of claim 1, wherein the co-solvent comprises at least one of: 1-methoxy-2-propanol, ethylene glycol diacetate, 1,2-propanediol monomethyl ether acetate, or dipropylene glycol monomethyl ether.

7. The method of claim 1, wherein the fluorinated solvent is methyl nonafluorobutyl ether and the co-solvent is ethylene glycol diacetate.

8. The method of claim 1, wherein the composition is an azeotrope or an azeotrope-like composition.

9. The method of claim 1 wherein the composition further comprises a corrosion inhibitor, a surfactant, a lubricant, an acid, or a combination thereof.

10. The method of claim 9, wherein the acid comprises hydrofluoric acid and/or nitric acid.

11. The method of claim 9, wherein the surfactant comprises a fluorosurfactant.

12. An article treated by the method of claim 1.

13. A process comprising:
providing a substrate having at least a portion coated with a photoresist;
implanting ions in at least a portion of the substrate coated with the photoresist resulting in a substrate with an ion implanted region and at least a portion of the photoresist that is implanted with ions;
removing at least a portion of the photoresist that is implanted with ions with a composition comprising a fluorinated solvent and a co-solvent.

14. The process of claim 13 further comprising depositing a metal or alloy onto the substrate.

15. The process of claim 14 wherein the metal comprises tungsten.

16. The process of claim 13 further comprising at least partially ashing the substrate with an ion implanted region and at least a portion of the photoresist that is implanted with ions.

17. The process of claim 13, wherein the ions include at least one of an arsenic ion, a boron ion, and a gallium ion.

18. The process of claim 13 further comprising providing an interconnect layer onto the substrate after removing at least a portion of the photoresist implanted with ions, wherein the interconnect layer comprises an insulator material and a metal interconnect.

19. The process of claim 18, wherein the insulator material comprises a low dielectric constant material.

20. The process of claim 18, wherein the metal interconnect comprises copper.
